(19) United States
(12) Patent Application Publication
(10) Pub. No.: US 2008/0162903 A1
(43) Pub. Date: Jul. 3, 2008

(54) Information processing apparatus

(75) Inventor: Yasuhiro Yamazaki, Kanoku (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/907,617

(22) Filed: Oct. 15, 2007

(30) Foreign Application Priority Data
Dec. 28, 2006 (JP) 2006-355762

(51) Int. Cl. G06F 9/38

(52) U.S. Cl. 712/233; 712/E09.045

(57) ABSTRACT

There is provided an information processing apparatus characterized by including: an instruction cache memory storing an instruction; a first adder adding a program counter relative branch target address in an inputted branch instruction and a program counter value, and outputting an absolute branch target address; and a write circuit converting the program counter relative branch target address in the inputted branch instruction into the absolute branch target address and writing a converted branch instruction thereof in the instruction cache memory.

### CROSS-REFERENCE TO RELATED APPLICATIONS

This application is based upon and claims the benefit of priority from the prior Japanese Patent Application No. 2006-355762, filed on Dec. 28, 2006, the entire contents of which are incorporated herein by reference.

### BACKGROUND OF THE INVENTION

1. Field of the Invention

The present invention relates to an information processing apparatus, and particularly relates to an information processing apparatus which processes a branch instruction.

2. Description of the Related Art

FIG. 11 is a chart showing an example of an instruction group 1101 including a branch instruction. An Add instruction (addition instruction) in the first line means GR3=GR1+GR2. Specifically, this Add instruction is an instruction to add values of registers GR1 and GR2 and store the result in a register GR3.

A Subcc instruction (subtraction instruction) in the second line means GR4=GR3−0×8 (hexadecimal number). Specifically, this Subcc instruction is an instruction to subtract 0×8 (hexadecimal number) from a value in the register GR3 and store the result in a register GR4. At this time, a zero flag turns to 1 when the operation result is 0, or otherwise turns to 0.

A BEQ instruction (branch instruction) in the third line is an instruction to branch to the address of a label name Target0 when the zero flag is 1, or proceeds to the next address without branching when the zero flag is 0. Specifically, the instruction branches to an And instruction in the sixth line when the zero flag is 1, or proceeds to an And instruction in the fourth line when the zero flag is 0.

The And instruction in the fourth line (logical multiplication instruction) means GR10=GR8 & GR4. Specifically, this And instruction is an instruction to operate a logical multiplication of values of registers GR8 and GR4, and store the result in a register GR10.

An St instruction (store instruction) in the fifth line means memory (GR6+GR7)=GR10. Specifically, this St instruction is an instruction to store a value in the register GR10 in a memory at an address of a value of adding registers GR6 and GR7.

At the address of the label name Target0, an And instruction of the sixth line is stored. The And instruction of the sixth line means GR11=GR4 & GR9. Specifically, this And instruction is an instruction to operate a logical multiplication of values of the registers GR4 and GR9, and store the result in a register GR11.

An Ld instruction (load instruction) in the seventh line means GR10=memory (GR6+GR7). Specifically, this Ld instruction is an instruction to load (read) a value from a memory at the address of a value of adding the registers GR6 and GR7, and store the result in the register GR10.

Now, the BEQ instruction (branch instruction) in the third line determines whether or not to branch depending on the value of the zero flag. Therefore, a time (branch penalty) in which an instruction is not executed occurs after execution of the BEQ instruction (branch instruction). Generally, the branch penalty has 3 to 5 clock cycles, but there are also ones having 10 clock cycles or more. The branch penalty causes decrease in speed of executing the instruction group 1101.

FIG. 12 is a diagram showing pipeline processing of instructions. Below, reasons why the branch penalty occurs will be explained. The stages 130 to 134 denote pipeline stages respectively. First, in the first stage 130, an address for reading an instruction is calculated. Next, in the second stage 131, the instruction is read from an instruction cache memory. Next, in the third stage 132, a value is read from a register, and the instruction is interpreted (decoded). Next, in the fourth stage 133, an arithmetic unit operates and executes the instruction. Next, in the fifth stage 134, an operation result is written in a register.

In the case of the command group 1101 of FIG. 11, whether or not to branch is determined as a result of the operation and execution stage 133 for the BEQ instruction (branch instruction). In the case of branching, the process returns to the first stage 130 in step S1201, and the address of the label name Target0 as a branch target is calculated. Thereafter, the stages 131 to 133 are performed. Accordingly, after the operation and execution stage 133 for the BEQ instruction (branch instruction), a branch penalty occurs in a period until the operation and execution stage 133 of the And instruction as a next branch target is executed.

As above, modern microprocessors are pipelined. Pipelining is a scheme to process instructions in parallel on the assumption that the respective stages 130 to 134 are independent. However, there is dependency between stages regarding the branch instruction, and since the operation and execution stage 133 and the calculation stage 130 for an instruction read address are related, there occurs a time in which an instruction is not executed after the operation and execution stage 133. This is a cause of generating the branch penalty.

FIG. 13 is a diagram showing a method of reducing the branch penalty using a branch direction prediction. The branch direction prediction predicts whether or not to branch just after a branch instruction is read from the instruction cache memory in the stage 131. When it is predicted to branch, the process returns to the first stage 130 in step S1302, and the address of the label name Target0 as a branch target is calculated. Thereafter, in the operation and execution stage 133 of the branch instruction, whether or not to branch is determined. When the prediction is wrong, the process returns to the first stage 130 in step S1303, and a correct next instruction read address is calculated. When the prediction is correct, the branch penalty can be reduced. As the branch direction prediction, there are static prediction and dynamic prediction.

Next, the static prediction will be explained. Hint information is embedded in a branch instruction, and just after the branch instruction is read from the instruction cache memory in the stage 131, whether or not to branch is predicted based on the hint information. When it is predicted to branch, the process returns to the first stage 130 in step S1302, and the address of the label name Target0 as a branch target is calculated. Step S1303 thereafter is the same as described above.

Next, the dynamic prediction will be explained. A result of branching or not branching in the past is recorded in a history table, and whether or not to branch is predicted based on the history table. When it is predicted to branch, the process returns to the first stage 130 in step S1302, and the address of the label name Target0 as a branch target is calculated. Step S1303 thereafter is the same as described above.

FIG. 14 is a diagram showing a method of reducing the branch penalty using a BTB (Branch Target Buffer) The BTB is a buffer storing the address of a branch instruction itself and a branch target address. In the stage 131, step S1401 predicts whether a read branch instruction is to branch or not. When it is predicted to branch, in step S1402 the BTB inputs an “instruction read address” calculated in the stage 130 and outputs a “branch target address”. Next in step S1403, an instruction at the branch target address outputted in the stage 131 is read from the instruction cache memory. Thus, the address calculation stage 130 is bypassed, and a time for calculating the branch target address can be reduced.

Further, Patent Document 1 mentioned below describes an information processing apparatus in which an instruction fetcher prefetches an instruction from a cache memory based on branch prediction information.

Further, Patent Document 2 mentioned below describes an information processing apparatus characterized by including a storage means for storing a plurality of branch instructions including branch prediction information specifying branch directions, a prefetch means for prefetching an instruction to be executed next from the storage means according to the branch prediction information, and an update means for updating the branch prediction information of the branch instruction according to an execution result of the branch instruction.

[Patent Document 1] Japanese Laid-open Patent Application No. Hei 10-228377

[Patent Document 2] Japanese Laid-open Patent Application No. Sho 63-075934

The above-described dynamic branch direction prediction and the BTB are highly effective, but have a drawback that a semiconductor chip area and power consumption increase due to the use of the history table and the buffer.

### SUMMARY OF THE INVENTION

An object of the present invention is to provide an information processing apparatus capable of reducing a branch penalty and small in size and/or consuming low power.

An information processing apparatus of the present invention is characterized by including: an instruction cache memory storing an instruction; a first adder adding a program counter relative branch target address in an inputted branch instruction and a program counter value, and outputting an absolute branch target address; and a write circuit converting the program counter relative branch target address in the inputted branch instruction into the absolute branch target address and writing a converted branch instruction in the instruction cache memory.

Further, an information processing apparatus of the present invention is characterized by including: an instruction cache memory storing an instruction; and a write circuit rearranging, when a program counter relative branch instruction and another instruction are inputted in parallel, the program counter relative branch instruction and another instruction so that the program counter relative branch instruction is located at a certain position and writing rearranged instructions in the instruction cache memory, and writing rearrangement information thereof in the instruction cache memory.

### BRIEF DESCRIPTION OF THE DRAWINGS

FIG. 1 is a diagram showing a configuration example of an information processing apparatus according to an embodiment of the present invention;

FIG. 2 is a diagram showing the pipeline processing according to this embodiment;

FIG. 3 is a diagram showing a configuration example of a conversion circuit of FIG. 1;

FIG. 4 is a view for explaining an instruction cache memory of set associative scheme;

FIG. 5 is a diagram showing a configuration example of an instruction cache memory and an instruction fetch controller of FIG. 1;

FIG. 6 is a diagram showing processing of an instruction cache memory and an instruction fetch controller in a branch instruction read period and a branch target instruction read period;

FIG. 7 is a diagram showing a configuration example of the conversion circuit of FIG. 1;

FIG. 8 is a diagram in which one main memory and two CPUs are connected to a bus;

FIG. 9 is a diagram showing a configuration example of the conversion circuit in a CPU;

FIG. 10 is a diagram showing another configuration example of the conversion circuit of FIG. 1;

FIG. 11 is a chart showing an example of an instruction group including a branch instruction;

FIG. 12 is a diagram showing pipeline processing of instructions;

FIG. 13 is a diagram showing a method of reducing a branch penalty using a branch direction prediction; and

FIG. 14 is a diagram showing a method of reducing a branch penalty using a BTB (Branch Target Buffer).

### DETAILED DESCRIPTION OF THE PREFERRED EMBODIMENTS

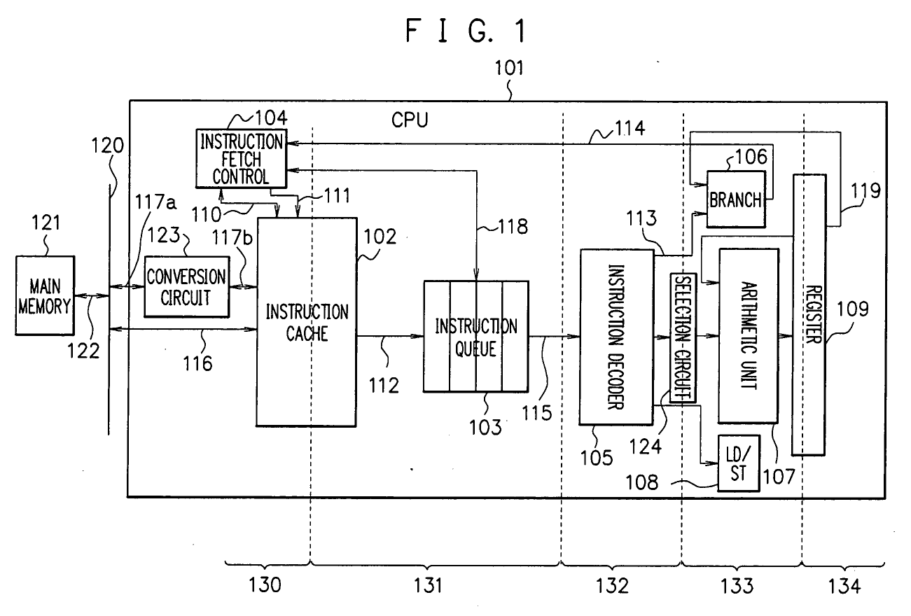

FIG. 1 is a diagram showing a configuration example of an information processing apparatus according to an embodiment of the present invention. This information processing apparatus performs five-stage pipeline processing including a first stage 130, a second stage 131, a third stage 132, a fourth stage 133, and a fifth stage 134.

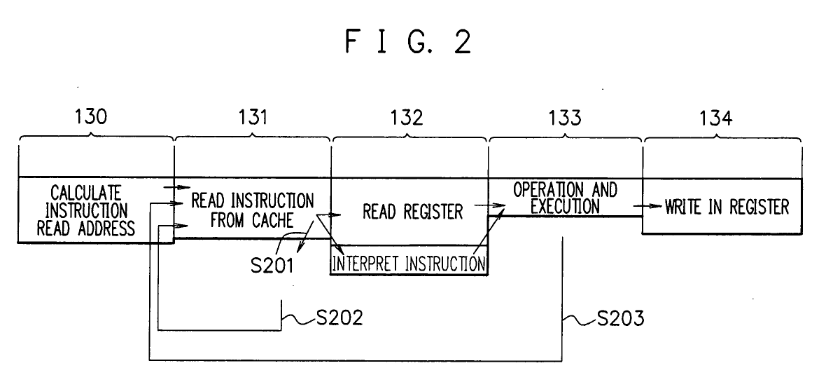

FIG. 2 is a diagram showing the pipeline processing according to this embodiment. The stages 130 to 134 show pipeline stages respectively. First, in the first stage 130, an instruction fetch controller 104 calculates an address for reading an instruction. Next, in the second stage 131, the instruction fetch controller 104 reads the instruction from an instruction cache memory 102 into an instruction queue 103. Next, in the third stage 132, the instruction decoder 105 reads a value from a register 109 and outputs the value to an arithmetic unit 107, and also interprets (decodes) the instruction. Next, in the fourth stage 133, the arithmetic unit 107 operates and executes the instruction. Next, in the fifth stage 134, an operation result from the arithmetic unit 107 is written in the register 109.

Detailed explanation will be given below. A CPU (central processing unit) 101 is a microprocessor and is connected to a main memory 121 via a bus 120. The main memory 121 is an SDRAM for example and is connected to the external bus 120 via a bus 122. The CPU 101 has the instruction cache memory 102, the instruction queue (prefetch buffer) 103, the instruction fetch controller 104, the instruction decoder 105, a branch unit 106, the arithmetic unit 107, a load and store unit 108, the register. 109, a conversion circuit 123 and a selection circuit 124.

The conversion circuit 123 is connected to the external bus 120 via a bus 117a, and is connected to the instruction cache memory 102 via a bus 117b. The instruction queue 103 is connected to the instruction cache memory 102 via an instruction bus 112. The instruction cache memory 102 reads and stores part of instructions (programs) used frequently from the main memory 121 in advance, and meanwhile ejects from one that is not used. A case that an instruction requested by the CPU 101 is present in the instruction cache memory 102 is called a cache hit. In the case of a cache hit, the CPU 101 can receive the instruction from the instruction cache memory 102. On the other hand, a case that an instruction requested by the CPU 101 is not present in the instruction cache memory 102 is called a cache miss. In the case of a cache miss, the instruction cache memory 102 performs a read request of the instruction to the main memory 121 by a bus access signal 116. The CPU 101 can read an instruction from the main memory 121 via the instruction cache memory 102. The transfer speed of the bus 112 is quite fast as compared to the transfer speed of the external bus 120. Therefore, in the case of a cache hit, an instruction reading speed is quite fast as compared to the case of a cache miss. Further, the cache hit rate becomes high since the possibility for instructions (programs) to be read sequentially becomes high, and therefore the instruction reading speed of the CPU 101 becomes fast entirely by providing the instruction cache memory 102.

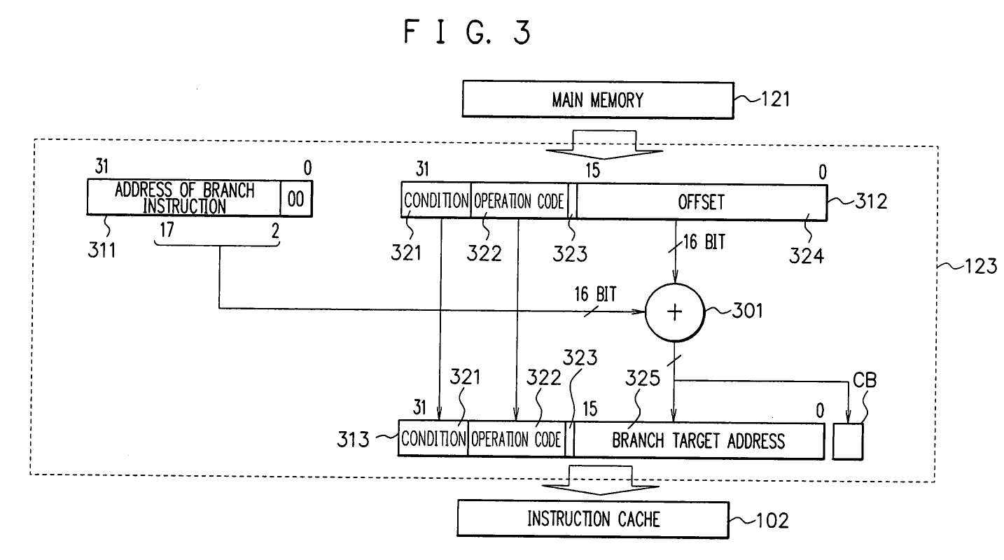

The conversion circuit 123 is connected between the main memory 121 and the instruction cache memory 102, and has a write circuit which converts, when an instruction read from the main memory 121 is a branch instruction, a program counter relative branch target address in the branch instruction into an absolute branch target address, and writes the converted branch instruction in the instruction cache memory 102. Details thereof will be described later with reference to FIG. 3.

The instruction queue 103 is capable of storing a plurality of instructions, and is connected to the instruction cache memory 102 via the bus 112 and to the instruction decoder 105 via a bus 115. Specifically, the instruction queue 103 writes an instruction from the instruction cache memory 102, reads the instruction, and outputs the instruction to the instruction decoder 105. The instruction fetch controller 104 inputs/outputs a cache access control signal 110 from/to the instruction cache memory 102, and controls inputting/outputting of the instruction queue 103. The instruction decoder 105 decodes an instruction stored in the instruction queue 103.

The arithmetic unit 107 is capable of simultaneously executing a plurality of instructions. When there are instructions which can be executed simultaneously among instructions decoded by the instruction decoder 105, the selection circuit 124 selects a plurality of instructions to be executed simultaneously and outputs selected instructions to the arithmetic unit 107. The arithmetic unit 107 inputs a value from the register 109, and operates and executes instructions decoded by the instruction decoder 105 one by one or several instructions simultaneously. An execution result from the arithmetic unit 107 is written in the register 109. The load and store unit 108 performs loading or storing between the register 109 and the main memory 121 when an instruction decoded by the instruction decoder 105 is a load or store instruction.

When an instruction read from the instruction cache memory 102 is a branch instruction, the instruction fetch controller 104 requests a prefetch of a branch target instruction thereof, or otherwise requests a prefetch of instructions sequentially. Specifically, the instruction fetch controller 104 requests a prefetch by outputting a cache access control signal 110 to the instruction cache memory 102. By the prefetch instruction, the instruction is prefetched from the instruction cache memory 102 to the instruction queue 103.

Thus, the prefetch request of a branch target instruction is performed at the stage of reading from the instruction cache memory 102 before executing a branch instruction. Thereafter, whether or not to branch is determined at the stage of executing the branch instruction. In other words, an instruction just before a branch instruction is executed by the operation in the arithmetic unit 107, and the execution result is written in the register 109. The execution result 119 in this register 109 is inputted to the branch unit 106. The branch instruction is executed by the operation in the arithmetic unit 107, and information indicating whether a branch condition is met or not is inputted to the branch unit 106 via for example a flag provided in the register 109. The instruction decoder 105 outputs a branch instruction decode notification signal 113 to the branch unit 106 when an instruction decoded by the instruction decoder 105 is a branch instruction. The branch unit 106 outputs a branch instruction execution notification signal 114 to the instruction fetch controller 104 depending on the branch instruction decode notification signal 113 and the branch instruction execution result 119. Specifically, depending on the execution result of the branch instruction, whether or not to branch is notified using the branch instruction execution notification signal 114. In the case of branching, the instruction fetch controller 104 prefetches the branch target instruction, which is requested to be prefetched as above, to the instruction queue 102. In the case of not branching, the instruction fetch controller 104 ignores and does not perform the prefetch of the branch target instruction which is requested to be prefetched as above, but prefetches, decodes and executes instructions in sequence, and also outputs an access cancel signal 111 to the instruction cache memory 102. The instruction cache memory 102 has already received the above-described prefetch request of the branch target, and is in an attempt to access the main memory 121 in the case of a cache miss. When the access cancel signal 111 is inputted, the instruction cache memory 102 cancels the access to the main memory 121. Thus, unnecessary access to the main memory 121 is eliminated, and decrease in performance can be prevented.

Note that for the sake of simplicity in explanation, the execution result 119 is shown to be inputted from the register 109 to the branch unit 106, but in practice, a bypass circuit can be used to input the execution result 119 to the branch unit 106 without waiting for the completion of execution of the execution stage 133.

When an instruction is read from the main memory 121 into the instruction cache memory 102, and then the read instruction is a branch instruction, the conversion circuit 123 calculates an absolute branch target address thereof, and writes the address in the instruction cache memory 102. Thereby, in the stage 131, when an instruction is read from the instruction cache memory 102 in step S201, and the instruction is a branch instruction and it is predicted to branch, the stage 130 is bypassed in step S202 and the instruction of a branch target address can be read from the instruction cache memory 102 in the stage 131. At this time, without using a history table or a buffer, the stage 130 can be bypassed so as to reduce the branch penalty. Thereafter, whether or not to branch is determined by the operation and execution stage 133 of the branch instruction. When the prediction is wrong, the predicted instruction is cancelled, and the process returns to the second stage 131 in step S203 to read the next instruction from the instruction cache memory 102. When the prediction is correct, the branch penalty can be reduced.

FIG. 3 is a diagram showing a configuration example of the conversion circuit 123 of FIG. 1. When an instruction 312 inputted from the main memory 121 is a branch instruction, the conversion circuit 123 converts a relative branch target address 324 in the branch instruction 312 into an absolute branch target address 325, and outputs a converted instruction 313 thereof to the instruction cache memory 102. The conversion circuit 123 has an adder 301.

The case where the program counter relative branch instruction 312 is inputted from the main memory 121 will be explained. A program counter value 311 is a value read from a program counter in the register 109 of FIG. 1, and shows an address of 32 bits in the main memory 121 which is currently read and processing is executed thereon. When the program counter relative branch instruction 312 is inputted, the program counter value 311 becomes the same value as the address of the program counter relative branch instruction 312.

One instruction is 32-bit (4-byte) in length. The branch instruction 312 includes a condition 321, an operation code 322, hint information 323 and an offset (program counter relative branch target address) 324. The condition 321, the operation code 322 and the hint information 323 are 16 bits from the 16th bit to the 31st bit of the branch instruction 312. The offset 324 is from the 0th bit to the 15th bit of the branch instruction 312. The condition 321 is a condition for determining whether or not to branch, and is a zero flag, a carry flag, or the like for example. The condition 321 of the BEQ instruction is a zero flag. The operation code 322 shows the type of an instruction. By checking the operation code 322 in an instruction, the conversion circuit 123 can determine whether this instruction is a branch instruction or not. The hint information 323 is hint information for predicting whether the branch instruction 312 is to branch or not. The offset 324 is a program counter relative branch target address, and is a relative address on the basis of the program counter value 311. When the branch instruction 312 is to branch, it branches to the address shown by the program counter relative branch target address 324.

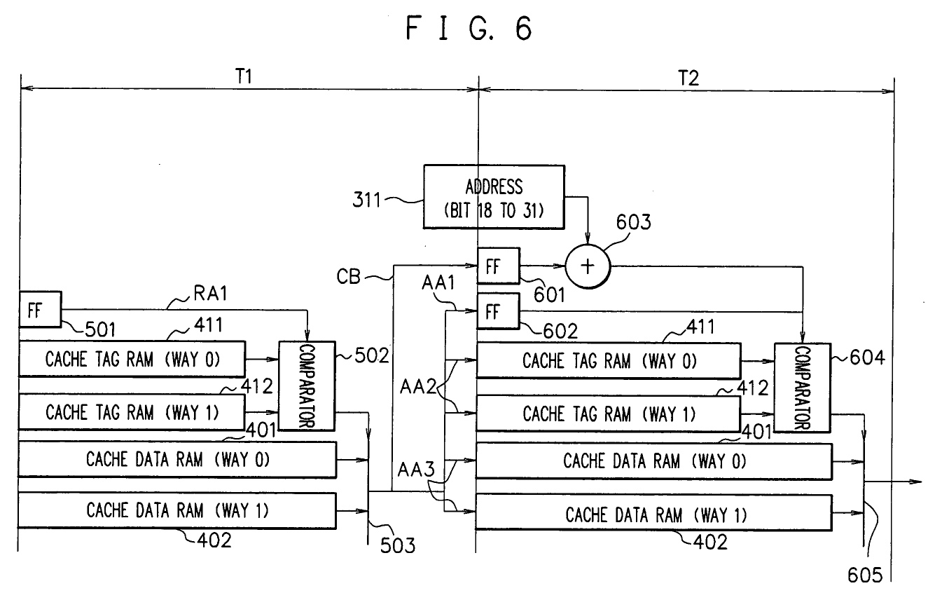

When the conversion circuit 123 determines that an input instruction is a branch instruction, the adder 301 adds the offset 324 of 16 bits in the branch instruction 312 and 16 bits from the second bit to the 17th bit of the program counter value 311, and outputs an absolute branch target address. Note that since the instruction length is 32-bit in length, the 0th bit and the first bit of the program counter value 311 always become “00 (binary number)”. Therefore, the adder 301 does not need to add the lower-order 2 bits of the program counter value 311. Further, the adder 301 has not added 14 bits from the 18th bit to the 31st bit of the program counter value 311 here, but these 14 bits are added in the processing of FIG. 6 later. Details thereof will be explained later.

The output of the adder 301 includes the absolute branch target address 325 of lower-order 16 bits and carry information CB of two bits. The carry information CB includes information of carry-up and carry-down. The conversion circuit 123 converts the program counter relative branch target address 324 in the inputted branch instruction 312 into the absolute branch target address 325 and writes converted branch instruction 313 thereof and the carry information CB in the instruction cache memory 102. In other words, the branch instruction 313 is a branch instruction made by converting the program counter relative branch target address 324 in the branch instruction 312 into the absolute branch target address 325.

As above, the program counter value 311 is divided into the higher-order 14 bits and the lower-order 18 bits. The adder 301 adds all or part of the lower-order 18 bits in the program counter value 311 and the program counter relative branch target address 324.

The absolute branch target address outputted by the adder 301 is divided into the absolute branch target address 325 of the same number of bits as the program counter relative branch target address 324 and the carry information CB. The conversion circuit 123 has a write circuit, which converts the program counter relative branch target address 324 in the branch instruction 312 into the absolute branch target address 325 and writes the converted branch instruction 313 and the carry information CB in the instruction cache memory 102.

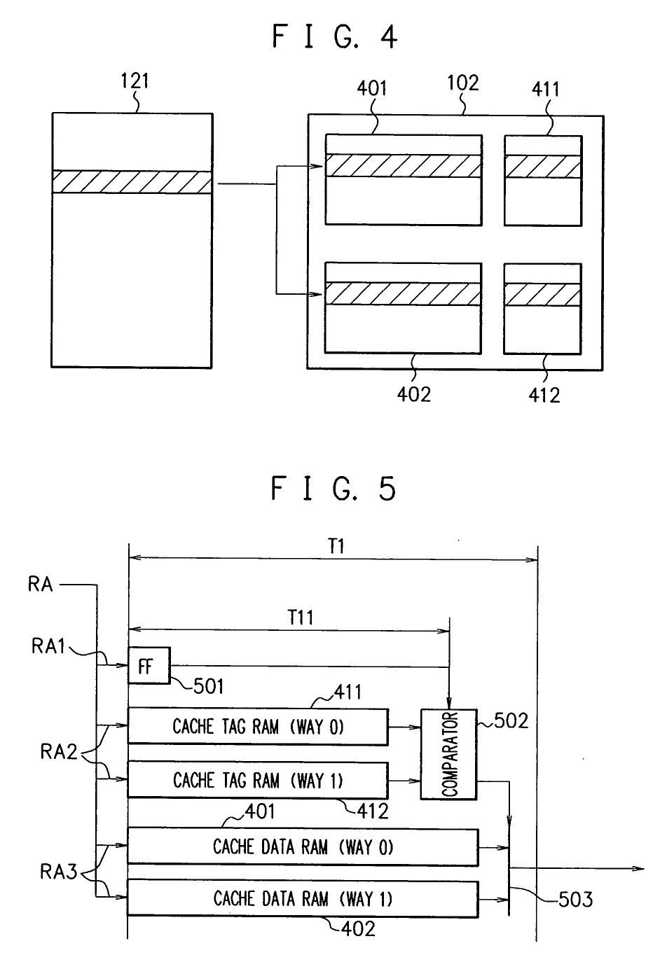

FIG. 4 is a view for explaining the instruction cache memory 102 of set associative scheme. As an example, a two-way set associative scheme will be explained. The instruction cache memory 102 has a cache data RAM 401 on a first way and a cache tag address RAM 411 corresponding thereto, and a cache data RAM 402 on a second way and a cache tag address RAM 412 corresponding thereto.

In the cache data RAMs 401 and 402, data of the main memory 121 are stored in units of blocks. In the cache tag address RAMs 411 and 412, addresses of data blocks stored in the cache data RAMs 401 and 402 are stored, respectively. The address of the instruction in the main memory 121 is 32-bit in length for example, and similarly to the above-described program counter value 311, the 0th bit and the first bit thereof always become “00 (binary number)”. 20 bits from the 12th bit to the 31st bit of an address thereof are stored in the cache tag address RAMs 411 and 412. Further, seven bits from the fifth bit to the 11th bit of the address represent positions in the respective cache tag address RAMs 411, 412. Further, three bits from the second bit to the fourth bit of the address represent positions in blocks of the cache data RAMs 401 and 402 shown in a tag address. As above, the instruction cache memory 102 stores instructions in the cache data RAMs 401, 402 and tag addresses (cache tag address RAMs 411, 412) of these instructions in a corresponding manner.

The block data in a same area in the main memory 121 can be stored in two places, the cache data RAM 401 on the first way and the cache data RAM 402 on the second way.

For the cache memory, there are a full associative scheme and a set associative scheme. The full associative scheme is not divided in ways, and has no limit in number of storable block data in a same area in the main memory 121 in the cache memory 102. The set associative scheme needs less number of comparisons of a request address and the cache tag address RAMs 411, 412 as compared to the full associative scheme.

FIG. 5 is a diagram showing a configuration example of the instruction cache memory 102 and the instruction fetch controller 104 of FIG. 1. The cache data RAMs 401, 402 and the cache tag address RAMs 411, 412 are provided in the cache memory 102. A flip-flop 501 and a comparator 502 are provided in the instruction fetch controller 104.

Hereinafter, there will be explained a procedure for the instruction fetch controller 104 to search for whether or not an instruction of a read address RA is stored in the instruction cache memory 102 and, when it is stored, read and output the instruction from the instruction cache memory 102.

The instruction fetch controller 104 calculates a read address RA in the stage 130 of FIG. 2. The read address RA is an address of 32 bits in the main memory 121. The tag address RA1 is an address of 20 bits from the 12th bit to the 31st bit of the read address RA. An index address RA2 is an address of seven bits from the fifth bit to the 11th bit of the read address RA. A block address RA3 is an address of ten bits from the second bit to the 11th bit of the read address RA.

The flip-flop 501 stores the tag address RA1 and outputs it to the comparator 502. The cache tag address RAM 411 outputs a tag address stored in a position corresponding to the index address RA2 to the comparator 502. The cache tag address RAM 412 outputs a tag address stored in a position corresponding to the index address RA2 to the comparator 502. The cache data RAM 401 outputs data stored in a position corresponding to the block address RA3 to a selector 503. The cache data RAM 402 outputs data stored in a position corresponding to the block address RA3 to the selector 503.

The comparator 502 compares whether or not the tag address RA1 outputted by the flip flop 501 is the same as the tag address outputted by the cache tag address RAM 411 or 412, and outputs a comparison result thereof to the selector 503.

The selector 503 selects data outputted by the cache data RAM 401 when the tag address RA1 is the same as the tag address outputted by the cache tag address RAM 411 or selects the data outputted by the cache data RAM 402 when the tag address RA1 is the same as the tag address outputted by the cache tag address RAM 412, and outputs the selected data to the instruction queue 103. Note that it is a cache miss when the tag address RA1 is different from either of the tag addresses outputted by the cache tag address RAMs 411 and 412, and then the instruction cache memory 102 performs a read request of an instruction to the main memory 121 by a bus access signal 116.

The horizontal axis on FIG. 5 also represents time. A period T1 denotes a cycle period of reading data of the read address RA from the instruction cache memory 102. The period T11 denotes a period from input of the read address RA to before comparison in the comparator 502. The tag address RA1 is not used in the period T11, but used for comparison in the comparator 502 thereafter. Accordingly, using this period T11, addition in an adder 603 of FIG. 6 is performed. Details thereof will be described below.

FIG. 6 is a diagram showing processing of the instruction cache memory 102 and the instruction fetch controller 104 in a branch instruction read period T1 and a branch target instruction read period T2. The period T1 is a period in which the instruction fetch controller 104 reads a branch instruction from the instruction cache memory 102. The period T2 is a period in which, when the branch instruction read from the period T1 is predicted to branch, the instruction fetch controller 104 reads a branch target instruction from the instruction cache memory 102.

In the period T1, similarly to the explanation of FIG. 5, the instruction fetch controller 104 reads the branch instruction of the read address RA from the instruction cache memory 102 and outputs the instruction from the selector 503. The selector 503 outputs the branch instruction 313 and the carry information CB shown in FIG. 3 in the instruction cache memory 102. The branch instruction 313 includes an absolute branch target address 325. The absolute branch target address 325 is an address of 16 bits from the second bit to the 17th bit of the absolute branch target address of 32 bits.

A tag address AA1 corresponds to a tag address RA1 (FIG. 5), and is an address of 6 bits from the 12th bit to the 17th bit of the absolute branch target address of 32 bits. An index address AA2 corresponds to the index address RA2 (FIG. 5), and is an address of seven bits from the fifth bit to the 11th bit of the absolute branch target address of 32 bits. The block address AA3 corresponds to the tag address RA3 (FIG. 5), and is an address of 10 bits from the second bit to the 11th bit of the absolute branch target address of 32 bits.

The flip-flop 601 stores the carry information CB and outputs it to the adder 603. The program counter value 311 is a value of the program counter, and currently at an address of a branch instruction read in the period T1. The adder 603 adds the address of 14 bits from the 18th bit to the 31st bit of the program counter value 311 and the carry information CB outputted by the flip flop 601, and outputs a tag address of 14 bits to a comparator 604. A flip-flop 602 stores the tag address AA1 and outputs it to the comparator 604. The comparator 604 inputs a tag address of 20 bits from the 12th bit to the 31st bit from the adder 603 and the flip-flop 602.

The cache tag address RAM 411 outputs a tag address stored in a position corresponding to the index address AA2 to the comparator 604. The cache tag address RAM 412 outputs the tag address stored in a position corresponding to the index address AA2 to the comparator 604. The cache data RAM 401 outputs data stored in a position corresponding to the block address AA3 to a selector 605. The cache data RAM 402 outputs data stored in a position corresponding to the block address AA3 to the selector 605.

The comparator 604 compares whether or not the tag addresses outputted by the adder 603 and the flip flop 602 are the same as tag addresses outputted by the cache tag address RAMs 411 or the 412, and outputs a comparison result thereof to the selector 605.

The selector 605 selects the data outputted by the cache data RAM 401 when the aforementioned tag addresses are the same as the tag address outputted by the cache tag address RAM 411 or selects the data outputted by the cache data RAM 402 when the aforementioned tag addresses are the same as the tag address outputted by the cache tag address RAM 412, and outputs the selected data to the instruction queue 103. Thus, the selector 605 can output a branch target instruction to the instruction queue 103.

Note that it is a cache miss when the tag addresses outputted by the adder 603 and the flip flop 602 are different from either of the tag addresses outputted by the cache tag address RAMs 411 and 412, and then the instruction cache memory 102 performs a read request of an instruction to the main memory 121 by a bus access signal 116.

As above, when a branch instruction written in the instruction cache memory 102 is read, the comparator 604 compares tag addresses based on the absolute branch target address 325 in the branch instruction, the carry information CB and higher-order bits in the program counter value 311 and tag addresses in the instruction cache memory 102. Further, the comparator 604 performs this comparison when the branch instruction is predicted to branch. The instruction fetch controller 104 has a read circuit which, when there is a match as a result of the comparison, reads a branch target instruction corresponding to the matched tag address from the instruction cache memory 102.

As above, in the conversion circuit 123 of FIG. 3, addition of a tag address from the 18th bit to the 31st bit of the program counter value 311 is not performed. In this embodiment, the adder 603 performs the addition of the tag address from the 18th bit to the 31st bit in parallel to read processing of a branch target instruction.

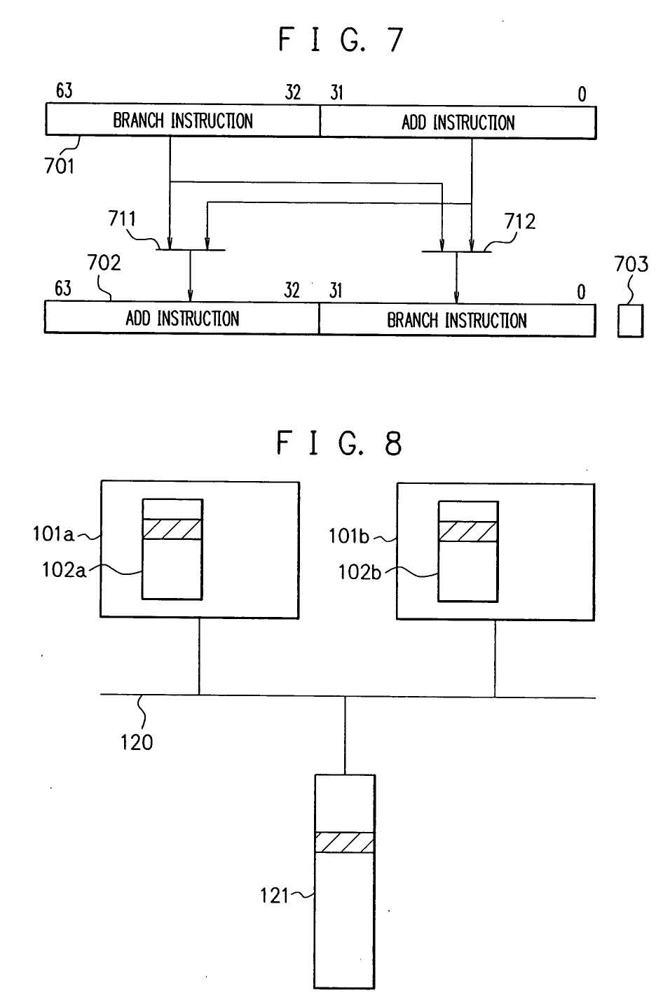

FIG. 7 is a diagram showing a configuration example of the conversion circuit 123 of FIG. 1. The instruction cache memory 102 inputs a plurality of instructions (two instructions for example) in parallel from the main memory 121, and the arithmetic unit 107 is capable of simultaneously executing a plurality of instructions in the instruction cache memory 102. In this case, the conversion circuit 123 needs to select a branch instruction from the plurality of instructions, and determine a branch target address in the branch instruction.

The conversion circuit 123 has a circuit which, when a program counter relative branch instruction and another instruction (for example Add instruction) are inputted in parallel, rearranges the program counter relative branch instruction and another instruction by selectors 711 and 712 so that the program counter relative branch instruction is located at a certain position, and writes them in the instruction cache memory 102 and writes rearrangement information 703 thereof in the instruction cache memory 102.

An instruction group 701 is two instructions inputted in parallel from the main memory 121 to the conversion circuit 123, and includes a branch instruction and an Add instruction. The branch instruction is located from the 32nd bit to the 63rd bit, and the Add instruction is located from the 0th bit to the 31st bit.

The selectors 711, 712 rearrange instructions in the instruction group 701 and output an instruction group 702. The conversion circuit 123 writes the instruction group 702 and the rearrangement information 703 in the instruction cache memory 102. The instruction group 702 is two instructions written in the instruction cache memory 102 by the conversion circuit 123 and includes an Add instruction and a branch instruction. The Add instruction is located from the 32nd bit to the 63rd bit, and the branch instruction is located from the 0th bit to the 31st bit.

The rearrangement information 703 includes information indicating which instruction a branch instruction is replaced with. The selectors 711 and 712 perform rearrangement so that a branch instruction is always located from the 0th bit to the 31st bit of the write instruction group 701 in the instruction cache memory 102. Thereby, the branch instruction is always read from the position from the 0th bit to the 31st bit, so that the speed to determine a branch target address in the branch instruction can be increased.

The selection circuit 124 of FIG. 1 has a control circuit to control the order of outputting a program counter relative branch instruction and other instructions to the arithmetic unit 107 based on the rearrangement information 703 in the instruction cache memory 102.

The arithmetic unit 107 is capable of executing a plurality of instructions simultaneously. The control circuit in the selection circuit 124 selects a plurality of instructions in the instruction cache memory 102 to be executed simultaneously based on the rearrangement information 703 and outputs the selected instructions to the arithmetic unit 107.

FIG. 8 is a diagram in which one main memory 121 and two CPUs 101a, 101b are connected to the bus 120. The CPU 101a has an instruction cache memory 102a, and the CPU 101b has an instruction cache memory 102b. The CPUs 101a and 101b correspond to the CPU 101 of FIG. 1, and the instruction cache memories 102a and 102b correspond to the instruction cache memory 102 of FIG. 1.

The two CPUs 101a, 102b each can read an instruction from the main memory 121 and write the instruction in the instruction cache memories 102a and 102b. By the above-described method, the CPU 101a converts a branch instruction in the main memory 121 from a program counter relative branch target address to an absolute branch target address and writes the converted branch instruction in the instruction cache memory 102a. When the CPU 101b is a typical CPU, the CPU 101b writes the branch instruction in the main memory 121 as it is to the instruction cache memory 102b.

Here, the CPU 101b can read an instruction directly from the instruction cache memory 102a in the CPU 101a and writes the instruction in the instruction cache memory 102b. In this case, the CPU 101a needs to return the branch instruction in the instruction cache memory 102a from the absolute branch target address to the program counter relative branch target address, and output the returned branch instruction to the CPU 101b. This also applies to the case of returning an instruction from a first instruction cache memory in the CPU 101a to a second instruction cache memory. A processing circuit thereof will be described below.

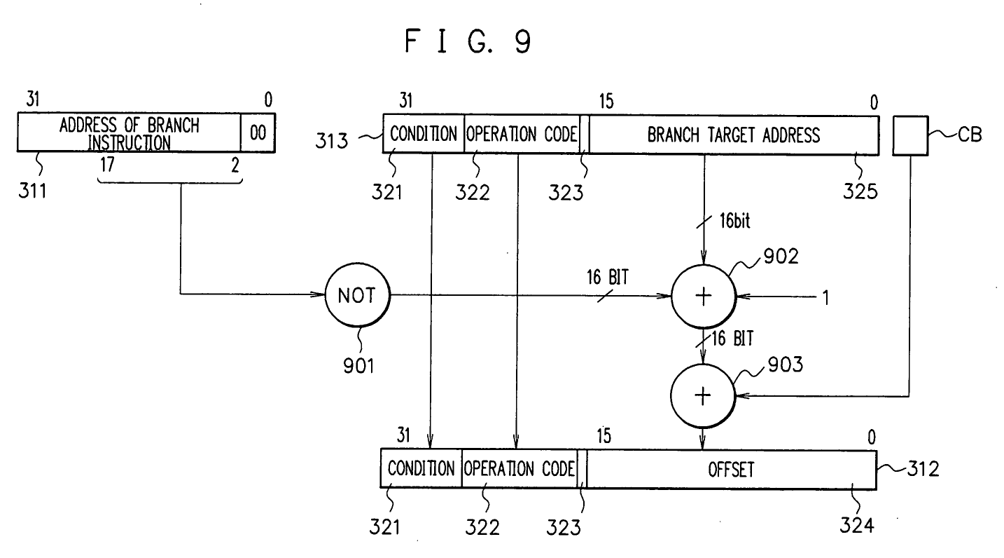

FIG. 9 is a diagram showing a configuration example of the conversion circuit 123 in the CPU 101a, and shows a circuit performing reverse conversion of the conversion of FIG. 3. The conversion circuit 123 reverse-converts the branch instruction 313 and the carry information CB in the instruction cache memory 102 into the original branch instruction 312, and outputs the branch instruction 312 to the CPU 101b. An inverter (NOT) circuit 901 logically inverts an address of 16 bits from the second bit to the 17th bit of the program counter value (the address of a branch instruction) 311, and outputs the address to an adder 902. A branch target address 325 is an absolute branch target address of 16 bits in the branch instruction 313. The adder 902 adds an address outputted by the NOT circuit 901 and the absolute branch target address 325 and 1, and outputs the result to an adder 903. As a result, as an output value of the adder 902, there is outputted an address value made by subtracting an address of 16 bits from the second bit to the 17th bit of the program counter value 311 from the absolute branch target address 325. Next, the adder 903 adds the address value outputted by the adder 902 and the carry information CB, and outputs the program counter relative branch target address 324.

The branch instruction 312 is an instruction of converting the absolute branch target address 325 in the branch instruction 313 to the program counter relative branch target address 324. The conversion circuit 123 outputs the branch instruction 312 to the other CPU 102b.

As above, the conversion circuit 123 has the adders 902 and 903 which operate the program counter relative branch target address 324 based on the absolute branch target address 325 in the branch instruction 313, the carry information CB and the program counter value 311, so as to convert the absolute branch target address 325 in the branch instruction 313 written in the instruction cache memory 102a and the carry information CB into the program counter relative branch target address 324 to thereby generate the original branch instruction 312. The adder 301 of FIG. 3 and the adders 902, 903 of FIG. 9 can be shared.

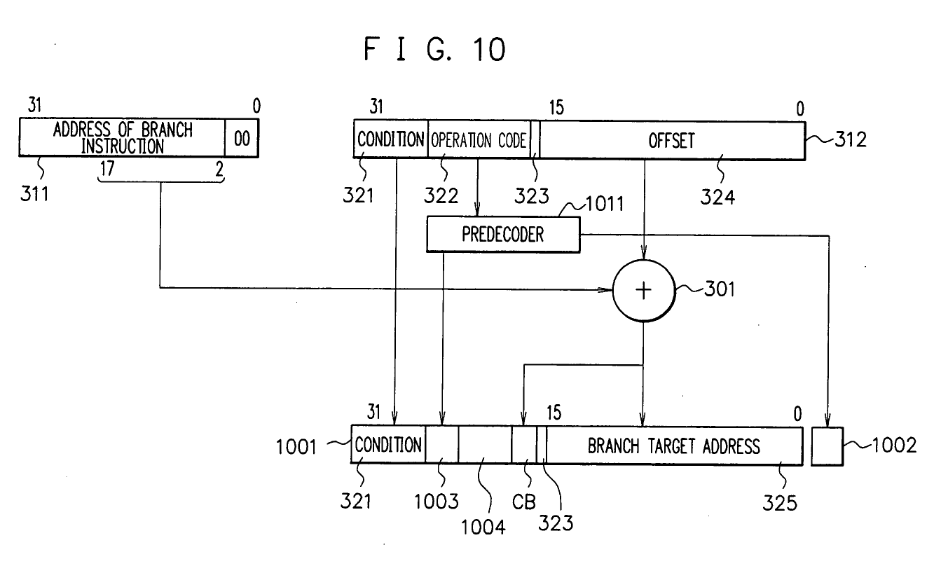

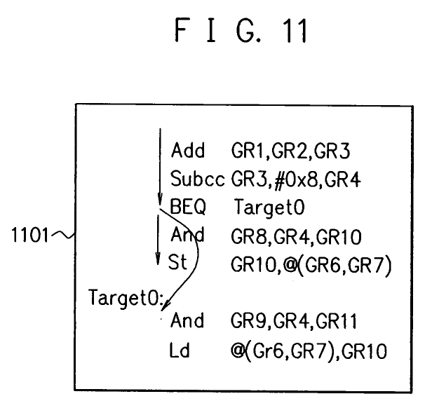

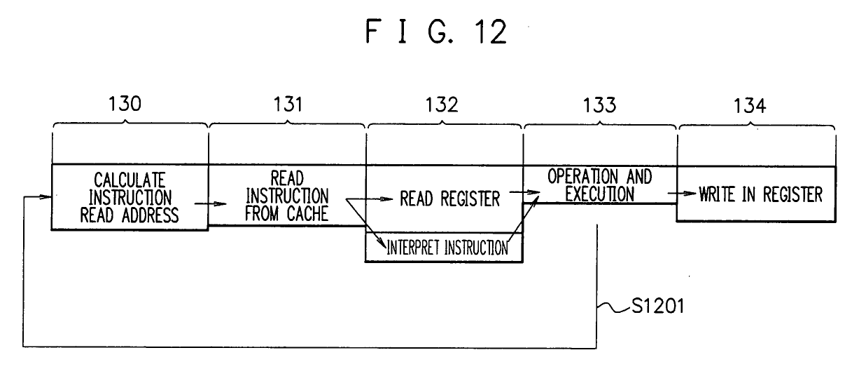

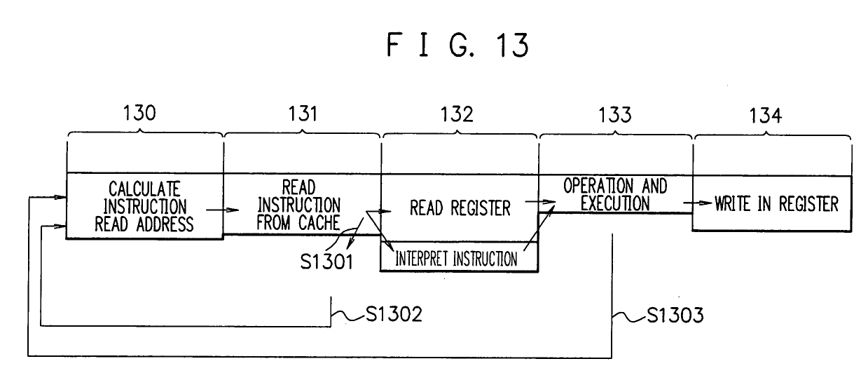

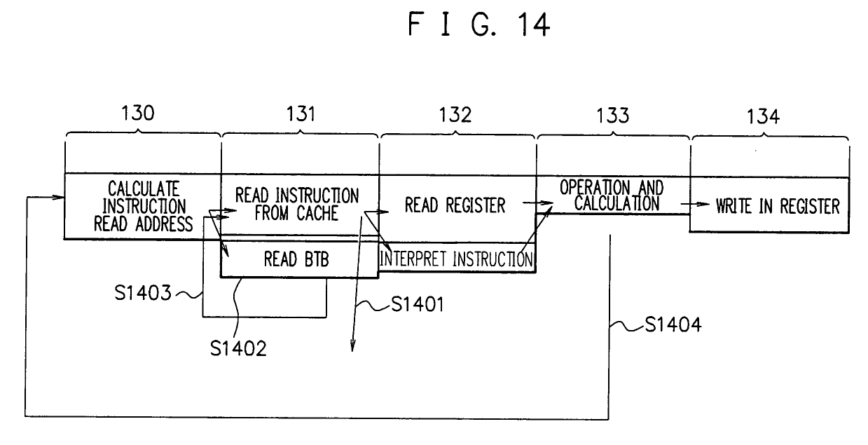

FIG. 10 is a diagram showing another configuration example of the conversion circuit 123 of FIG. 1. Hereinafter, the difference of FIG. 10 from FIG. 3 will be explained. When the instruction 312 inputted from the main memory 121 is a branch instruction, the conversion circuit 123 converts the program counter relative branch target address 312 in the branch instruction 312 into the absolute branch target address 325, and outputs a converted instruction 1001 thereof to the instruction cache memory 102. The conversion circuit 123 has the adder 301 and a predecoder 1011.

Similarly to FIG. 3, the adder 301 adds an address of 16 bits from the second bit to the 17th bit of the program counter value 311 and the program counter relative branch target address 324 in the branch instruction 312, and outputs the absolute branch target address 325 and the carry information CB.

The predecoder 1011 predecodes the operation code 322 in the branch instruction 312, and outputs branch instruction information 1002 of one bit indicating whether it is a branch instruction or not and an operation code 1003 indicating the type of the branch instruction.

The conversion circuit 123 writes the branch instruction 1001 after the conversion and the branch instruction information 1002 in the instruction cache memory 102. The program counter relative branch target address 324 in the branch instruction 312 is converted into the absolute branch target address 325 in the branch instruction 1001. Further, the operation code 322 in the branch instruction 312 is converted into the carry information CB in the branch instruction 1001, the operation code 1003 and a not-used region 1004. Besides that, the branch instructions 312 and 1001 are the same.

As above, the conversion circuit 123 has a write circuit which converts the operation code 322 in the branch instruction 312 into the carry information CB, and writes the converted branch instruction 1001 and the information 1002 indicating that it is a branch instruction in the instruction cache memory 102.

In the instruction cache memory 102, besides the branch instruction 1001, the information 1002 indicating that it is a branch instruction is stored. Since the instruction decoder 105 can determine that it is a branch instruction only by the branch instruction information 1002 of one bit, the operation code 1003 allows reducing the amount of information (number of bits) as compared to the operation code 322. Accordingly, the operation code 322 in the branch instruction 312 is converted into the operation code 1003 in the branch instruction 1001 and the carry information CB. Thus, the carry information CB can be arranged in the branch instruction 1001.

As above, according to this embodiment, when a program counter relative branch instruction is stored in the instruction cache memory, the time from reading the program counter relative branch instruction to accessing an instruction of a branch target address can be reduced by adding the program counter relative branch target address in a branch instruction and the program counter value (address of the branch instruction) and converting the program counter relative branch target address into the absolute branch target address. Thereby, without having a BTB, it is possible to reduce the branch penalty when the relative branch instruction is predicted to branch. Specifically, since the branch penalty can be reduced without using a history table or a buffer, the semiconductor chip area and/or power consumption can be reduced.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. An information processing apparatus, comprising:
an instruction cache memory storing an instruction;
a first adder adding a program counter relative branch target address in an inputted branch instruction and a program counter value, and outputting an absolute branch target address; and
a write circuit converting the program counter relative branch target address in the inputted branch instruction into the absolute branch target address and writing a converted branch instruction thereof in the instruction cache memory.

2. The information processing apparatus according to claim 1,
wherein the program counter value is divided into higher-order bits and lower-order bits; and
wherein the first adder adds the lower order-bits of the program counter value and the program counter relative branch target address.

3. The information processing apparatus according to claim 2,
wherein the absolute branch target address outputted by the first adder is divided into an absolute branch target address having a same number of bits as the program counter relative branch target address and carry information; and
wherein the write circuit converts the program counter relative branch target address in the branch instruction into the absolute branch target address, and writes a converted branch instruction thereof and the carry information in the instruction cache memory.

4. The information processing apparatus according to claim 3,
wherein the instruction cache memory stores an instruction and a tag address of the instruction in a corresponding manner,
the information processing apparatus further comprising:
a comparator comparing, when the branch instruction written in the instruction cache memory is read, a tag address based on an absolute branch target address in the branch instruction, the carry information and the higher-order bits of the program counter value with a tag address in the instruction cache memory; and
a read circuit reading, when there is a match as a result of the comparison, a branch target instruction corresponding to the matched tag address from the instruction cache memory.

5. The information processing apparatus according to claim 4,
wherein the comparator performs the comparison when the branch instruction is predicted to branch.

6. The information processing apparatus according to claim 4,
wherein when a program counter relative branch instruction and another instruction are inputted in parallel, the write circuit rearranges the program counter relative branch instruction and another instruction so that the program counter relative branch instruction is located at a certain position and writes rearranged instructions in the instruction cache memory, and writes rearrangement information thereof in the instruction cache memory.

7. The information processing apparatus according to claim 6, further comprising:
an arithmetic unit operating and executing an instruction; and
a control circuit controlling an order of outputting the program counter relative branch instruction and another instruction to the arithmetic unit based on the rearrangement information in the instruction cache memory.

8. The information processing apparatus according to claim 7,
wherein the arithmetic unit is capable of simultaneously executing a plurality of instructions, and
wherein the control circuit selects a plurality of instructions in the instruction cache memory to be simultaneously executed based on the rearrangement information and outputs selected instructions to the arithmetic unit.

9. The information processing apparatus according to claim 4, further comprising
a second adder operating a program counter relative branch target address based on the absolute branch target address in the branch instruction, the carry information and the program counter value, so as to convert the absolute branch target address in the branch instruction written in the instruction cache memory into the program counter relative branch target address to thereby generate the original branch instruction.

10. The information processing apparatus according to claim 9,
wherein the first adder and the second adder are shared.

11. The information processing apparatus according to claim 4,
wherein the write circuit converts an operation code in the branch instruction into the carry information, and writes converted branch instruction thereof and information indicating that the converted branch instruction is a branch instruction in the instruction cache memory.

12. The information processing apparatus according to claim 1,
wherein the absolute branch target address outputted by the first adder is divided into an absolute branch target address having a same number of bits as the program counter relative branch target address and carry information, and
wherein the write circuit converts the program counter relative branch target address in the branch instruction into the absolute branch target address, and writes a converted branch instruction thereof and the carry information in the instruction cache memory.

13. The information processing apparatus according to claim 1,
wherein the instruction cache memory stores an instruction and a tag address of the instruction in a corresponding manner,
the information processing apparatus further comprising:
a comparator comparing, when the branch instruction written in the instruction cache memory is read, a tag address based on an absolute branch target address in the branch instruction and the program counter value with a tag address in the instruction cache memory; and
a read circuit reading, when there is a match as a result of the comparison, a branch target instruction corresponding to the matched tag address from the instruction cache memory.

14. The information processing apparatus according to claim 13,
wherein the comparator performs the comparison when the branch instruction is predicted to branch.

15. The information processing apparatus according to claim 1, further comprising
a second adder operating a program counter relative branch target address based on the absolute branch target address in the branch instruction and the program counter value, so as to convert the absolute branch target address in the branch instruction written in the instruction cache memory into the program counter relative branch target address to thereby generate the original branch instruction.

16. The information processing apparatus according to claim 15,
wherein the first adder and the second adder are shared.

17. The information processing apparatus according to claim 3,
wherein the write circuit converts an operation code in the branch instruction into the carry information, and writes converted branch instruction thereof and information indicating that the converted branch instruction is a branch instruction in the instruction cache memory.

18. An information processing apparatus, comprising:
an instruction cache memory storing an instruction; and
a write circuit rearranging, when a program counter relative branch instruction and another instruction are inputted in parallel, the program counter relative branch instruction and another instruction so that the program counter relative branch instruction is located at a certain position and writing rearranged instructions in the instruction cache memory, and writing rearrangement information thereof in the instruction cache memory.

19. The information processing apparatus according to claim 18, further comprising:
an arithmetic unit operating and executing an instruction; and
a control circuit controlling an order of outputting the program counter relative branch instruction and another instruction to the arithmetic unit based on the rearrangement information in the instruction cache memory.

20. The information processing apparatus according to claim 19,
wherein the arithmetic unit is capable of simultaneously executing a plurality of instructions, and
wherein the control circuit selects a plurality of instructions in the instruction cache memory to be simultaneously executed based on the rearrangement information and outputs selected instructions to the arithmetic unit.
